(19) United States
(12) Patent Application Publication
(10) Pub. No.: US 2024/0144305 A1
(43) Pub. Date: May 2, 2024

(54) METHOD FOR ALLOCATING PERISHABLE PRODUCTS BASED ON MACHINE LEARNING SO AS TO OPTIMIZE AN ESTIMATED REVENUE

(71) Applicant: DUN-QIAN Intelligent Technology Co., Ltd., Taichung City (TW)

(72) Inventors: Yen-Chu Chen, Chiayi City (TW); Ling-Jung Lin, Tainan City (TW); Shao-Chen Liu, Taichung City (TW); Hsuan-Wei Chen, Taichung City (TW); Shuh-Shian Tsai, New Taipei City (TW)

(73) Assignee: DUN-QIAN Intelligent Technology Co., Ltd., Taichung City (TW)

(21) Appl. No.: 18/088,789

(22) Filed: Dec. 27, 2022

(30) Foreign Application Priority Data
Oct. 28, 2022 (TW) 111141039

(51) Int. Cl. G06Q 30/0202; G06Q 30/0204

(52) U.S. Cl. CPC G06Q 30/0202; G06Q 30/0204

(57) ABSTRACT

A method for allocating perishable products based on machine learning, includes using a sales estimation model to evaluate estimated sales of a plurality of perishable products in a predetermined period, using a rating model to calculate a predetermined rate of the plurality of perishable products in the predetermined period according to the estimated sales, using an allocation model to adjust an allocation ratio of the plurality of perishable products in a plurality of marketing channels according to the estimated sales and the predetermined rate if a current rate is lower than the predetermined rate, and determining the numbers of perishable products allocated to the plurality of marketing channels according to the allocation ratio.

### BACKGROUND OF THE INVENTION

### 1. Field of the Invention

The disclosure is related to a method for allocating perishable products, and more particularly, a method for allocating perishable products based on machine learning so as to optimize an estimated revenue.

### 2. Description of the Prior Art

When selling a plurality of products, the products can be sold through a plurality of marketing channels. For example, if a hotel has a plurality of room nights offered for booking, the room nights can be booked through multiple marketing channels such as online travel agencies, classic travel agencies and hotel websites. The rate of the products may vary due to the varying demand for the products (e.g. hotel room nights) from time to time. If the products have been offered at a lower rate, though more products could be sold, the profit margin is reduced, making it difficult to meet the revenue target. In order to deal with this problem, at present, operators rely on their personal instinct to adjust the allocation of products in different marketing channels. However, personal instinct is not a reliable source, especially it can not dynamically make adjustment to the allocation of the products in different marketing channels to cope with the ever changing market, making it difficult to optimize the overall revenue.

### SUMMARY OF THE INVENTION

An embodiment provides a method for allocating perishable products based on machine learning. The method includes using a sales estimation model to evaluate estimated sales of a plurality of perishable products during a predetermined period; using a rating model to calculate a predetermined rate of the plurality of perishable products in the predetermined period according to the estimated sales; using an allocation model to adjust an allocation ratio of the plurality of perishable products in a plurality of marketing channels according to the estimated sales and the predetermined rate if a current rate is lower than the predetermined rate; and determining the numbers of perishable products allocated to the plurality of marketing channels according to the allocation ratio.

Another embodiment provides a method for arranging perishable products based on machine learning. The method includes using a sales estimation model to evaluate estimated sales of a plurality of perishable products in a predetermined period; using a rating model to calculate a predetermined rate of the plurality of perishable products in the predetermined period according to the estimated sales; and closing a sales operation of a marketing channel corresponding to a current rate if the current rate is higher than the predetermined rate, wherein the marketing channel is one of a plurality of marketing channels.

Another embodiment provides a method for arranging perishable products based on machine learning. The method includes inputting a plurality of rates into a sales estimation model to evaluate estimated sales of a plurality of perishable products in a predetermined period; using a rating model to generate a function according to the plurality of rates and the estimated sales; using the rating model to generate a predetermined rate according to the function; using an allocation model to adjust an allocation ratio according to the estimated sales and the predetermined rate if a current rate is lower than the predetermined rate; and determining the numbers of perishable products allocated to a plurality of marketing channels according to the allocation ratio.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a system for allocating perishable products according to an embodiment.

FIG. 2 illustrates a method for allocating perishable products based on machine learning according to an embodiment.

FIG. 3 illustrates a flow of optimizing the rating model and the allocation model according to an embodiment.

FIG. 4 illustrates a method for allocating perishable products based on machine learning according to another embodiment.

### DETAILED DESCRIPTION

In order to adjust the numbers of the products in a plurality of marketing channels to optimize the estimated revenue, a method for allocating the products based on machine learning can be performed. In the text, a product can be a perishable product with a limited life, such as hotel room, air ticket, sports ticket and so on. For example, the mentioned machine learning can include reinforcement learning and be performed with neural network. In the text, a marketing channel for selling products can be referred to as a channel for short.

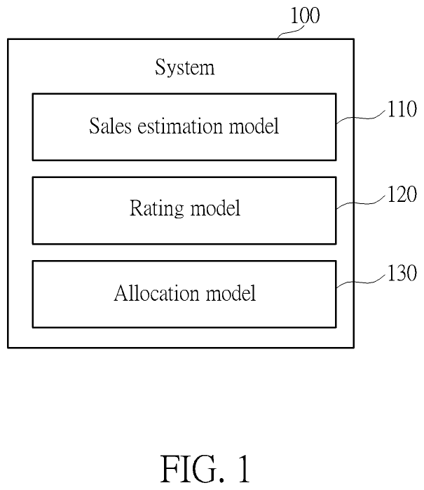

FIG. 1 illustrates a system 100 for allocating perishable products according to an embodiment. The system 100 can include a sales estimation model 110, a rating model 120 and an allocation model 130. Each of the sales estimation model 110, the rating model 120 and the allocation model 130 can include a neural network, and the neural network can be trained to be improved.

The sales estimation model 110 can evaluate estimated sales. For example, if the products are hotel room nights, the sales estimation model 110 can evaluate the estimated sales according to historical sales data, weather data, news, economic data and room rates of competing hotels obtained from online travel agencies (OTAs). The unit of the estimated sales can be room night. When N rooms are booked for M days, the number of room nights can be the product of N and M (i.e. N×M). For example, when one room is booked for one day, the number of room nights can be 1. When one room is booked for two days, the number of room nights can be 2. When two rooms are booked for one day, the number of room nights can also be 2. The rating model 120 can generate a predetermined rate of the products. For example, the rating model 120 can generate the predetermined rate according to the estimated sales.

The allocation model 130 can adjust an allocation ratio and the numbers of the products allocated to a plurality of channels. For example, the allocation model 130 can generate the allocation ratio of 50 hotel room nights in 3 channels in a percentage term. By multiplying the allocation ratio and the total number of hotel room nights, the number of hotel room nights in each channel can be calculated. If the calculation result is not an integer, it can be rounded to be an integer. After performing the calculation, if the sum of numbers of products allocated to the channels is not equal to the total number of products, the number of products can be increased or decreased in any of the channels to make up the deficiency.

The sales estimation model 110, the rating model 120 and the allocation model 130 in the system 100 can be implemented using hardware, such as central processing unit (CPU), tensor processing unit (TPU) and/or graphics processing unit (GPU), and related software and firmware. The sales estimation model 110, the rating model 120 and the allocation model 130 in the system 100 can be implemented with different hardware devices separately, or integrated into a same hardware device. The sales estimation model 110, the rating model 120 and the allocation model 130 can be implemented with different neural networks, or be integrated with the same neural network and be realized with different agent programs.

The sales estimation model 110, the rating model 120 and/or the allocation model 130 can be updated recursively to obtain optimal weights. As a result, the sales estimation model 110, the rating model 120 and/or the allocation model 130 can be optimized to optimize the estimated revenue of selling the products in the plurality of channels.

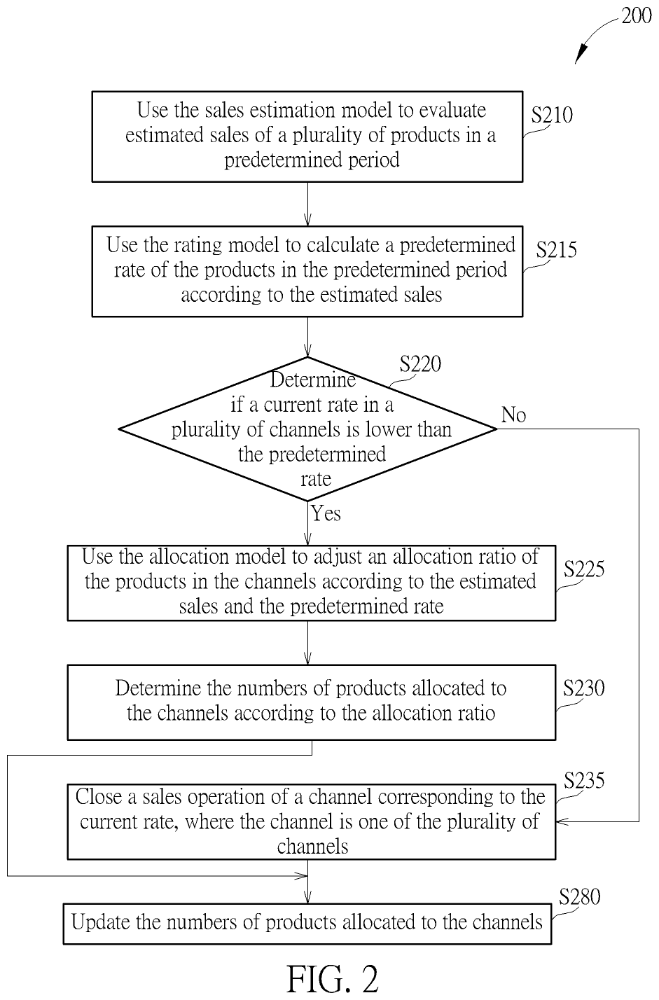

FIG. 2 illustrates a method 200 for allocating perishable products based on machine learning according to an embodiment. The method 200 can include the following steps.
Step S210: use the sales estimation model 100 to evaluate estimated sales (expressed as Se) of a plurality of products in a predetermined period (expressed as Td);
Step S215: use the rating model 120 to calculate a predetermined rate (expressed as Pe) of the products in the predetermined period Td according to the estimated sales Se;
Step S220: determine if a current rate (expressed as Pc) in a plurality of channels is lower than the predetermined rate Pe; if so, enter Step S225; else, enter Step S235;
Step S225: use the allocation model 130 to adjust an allocation ratio (expressed as Rt) of the products in the channels according to the estimated sales Se and the predetermined rate Pe;
Step S230: determine the numbers of products allocated to the channels according to the allocation ratio Rt; enter Step S280;
Step S235: close a sales operation of a channel corresponding to the current rate Pc, where the channel is one of the plurality of channels; and
Step S280: update the numbers of products allocated to the channels.

Below, the method 200 is explained with an example, where the products can be a plurality of hotel room nights. In Step S210, the predetermined period can be the next 30 days. The estimated sales Se can be the sales during the next 30 days. As mentioned above, the unit of the estimated sales Se of hotel room can be room night.

In Step S215, the predetermined rate Pe can be an allowable upper rate bound. In other words, if the room rate in a channel is higher than the predetermined rate Pe, it is not allowed to continue to market the product in the channel.

For example, if the estimated sales Se is higher, the expected popularity of the products in the predetermined period Td may be higher, and the predetermined rate Pe may be higher. In the process of selling a plurality of perishable products (e.g. hotel room nights), the product that is sold last can often have the highest rate, so the predetermined rate Pe may be the rate of the last product (e.g. the last hotel room).

Regarding the predetermined rate Pe in Step S215, an estimated revenue (expressed as SAe) can be generated according to the estimated sales Se in Step S210. The rating model 120 can calculate the predetermined rate Pe according to the estimated revenue SAe and the number of the products. For example, if the products are 50 hotel room nights, and the estimated revenue SAe in the predetermined period Td (e.g. next 30 days) is 10,000 dollars, the predetermined rate Pe can be an average such as 10,000 dollars/50 room nights, that is 200 dollars/per room night. Here, the example is for explanation, and embodiments are not limited thereto.

In Step S220, it can be checked if the current rate Pc in one of the channels is lower than the predetermined rate Pe generated in Step S215. If so, the flow can enter Step S225 to keep selling the product. If not, the flow can enter Step S235, and the product is no longer marketed in the channel corresponding to the current rate Pc.

Regarding Step S230, an example is given below. If the products are 50 hotel room nights, and the channels include an online travel agency channel (expressed as CH1), a physical travel agency channel (expressed as CH2) and a hotel self-operated channel (expressed as CH3), the allocation ratio Rt and the corresponding numbers of room nights marketed in the channels can be as shown in Table 1. As shown in Table 1, the allocation ratio Rt of the channels CH1 to CH3 can be [34.8%, 41.9%, 23.3%]. Hence, it can be calculated that the numbers of room nights to be allocated to the channels CH1 to CH3 can be 17.40, 20.95 and 11.65 respectively. After rounding the numbers to the whole number or processing the numbers with a proper process, the numbers of room nights allocated to the channels CH1 to CH3 can be 17, 21 and 12 respectively. After performing the calculation, if the sum of the numbers of room nights allocated to the channels is not equal to the total number of room nights, the number of room nights can be adjusted to make up the deficiency. For example, in the channel with the most room nights or the least room nights, the number of room nights can be increased or decreased to make the total number of room nights allocated to all channels equal to the total number of room nights. Table 1 is an example, and embodiments are not limited thereto.

TABLE 1

| Channel | CH1 | CH2 | CH3 | Sum |
|---|---|---|---|---|
| Allocation ratio Rt | 34.8% | 41.9% | 23.3% | 100% |
| (Total number of | 17.40 | 20.95 | 11.65 | 50 |
| room nights) × | | | | |
| Allocation ratio Rt | | | | |
| Rounded to whole | 17 | 21 | 12 | 50 |
| number | | | | |

In Step S235, the current rate Pc in the channels is higher than the predetermined rate Pe, it means the current rate Pc is higher than the allowable upper rate bound, and the rate should be adjusted. Hence, the sales operation in the channel corresponding to the current rate Pc should be closed. After that, the at least one product allocated to the channel corresponding to the current rate Pc can be reallocated to other channels for sale. For example, when the sales operation of an online travel agency is closed for overpricing, the room nights that were allocated to the online travel agency can be reallocated to other channels.

In Step S235, the marketing operation in the channel corresponding to the current rate Pc can be closed through an application programming interface (API). In Step S280, the numbers of products allocated to the channels can be updated synchronously through an application programming interface (API).

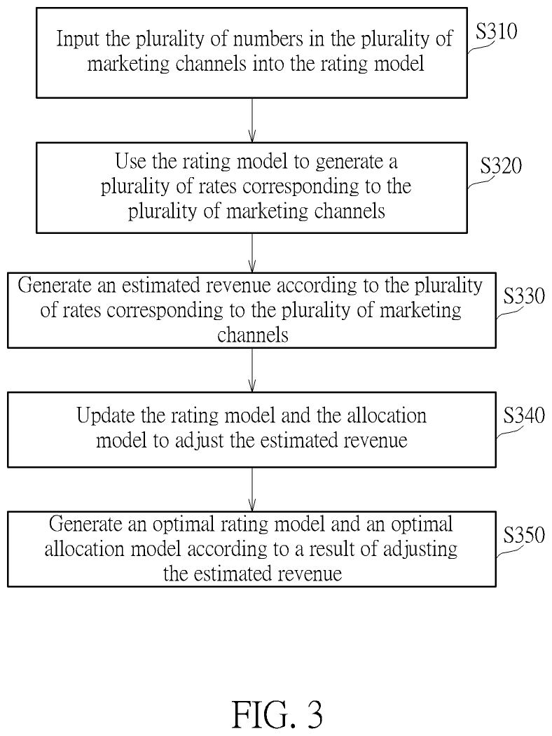

FIG. 3 illustrates a flow of optimizing the rating model 120 and the allocation model 130 according to an embodiment. The flow can include the following steps.
Step S310: input the plurality of numbers in the plurality of marketing channels into the rating model 120;
Step S320: use the rating model 120 to generate a plurality of rates corresponding to the plurality of marketing channels;
Step S330: generate an estimated revenue according to the plurality of rates corresponding to the plurality of marketing channels;
Step S340: update the rating model 120 and the allocation model 130 to adjust the estimated revenue; and
Step S350: generate an optimal rating model 120 and an optimal allocation model 130 according to a result of adjusting the estimated revenue.

In Step S320, the rating model 120 can generate the rates according to previous training and setting. When the rates are higher, the profit per sale can be higher. However, if the rates are too high, it would lead to a decrease in sales, and the revenue would decrease. Hence, the rating model 120 should generate appropriate rates. In Step S340, weights in the neural networks of the rating model 120 and the allocation model 130 can be updated to adjust the estimated revenue. Afterward, the optimal rating model 120 and the optimal allocation model 130 can be generated according to the result of adjusting the estimated revenue. The rating model 120 and the allocation model 130 corresponding to the highest estimated revenue can be the optimal rating model 120 and the optimal allocation model 130. For example, if the products are hotel room nights, the numbers of room nights allocated to the channels can be the factors in the flow of training the rating model 120, and the rating model 120 can generate the room rates allocated to the channels accordingly. Then, revenues of each training epoch can be calculated. The rating model 120 and the allocation model 130 can be updated synchronously and recursively. After a convergence condition is reached (e.g. the highest revenue is found), the training flow can be completed and the optimal neural network models can be saved. Here, an epoch is completed when all the training data is used at once and is defined as the total number of iterations of all the training data in one cycle for training the machine learning model.

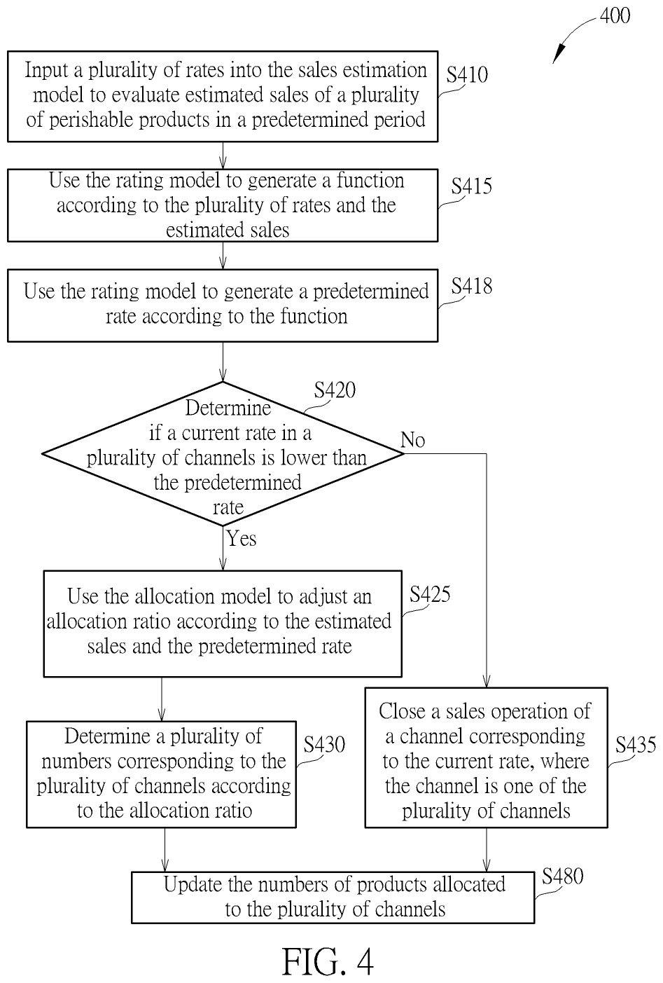

FIG. 4 illustrates a method 400 for allocating perishable products based on machine learning according to another embodiment. The method 400 can include the following steps.
Step S410: input a plurality of rates (expressed as P) into the sales estimation model 110 to evaluate estimated sales (expressed as S) of a plurality of perishable products in a predetermined period Td;
Step S415: use the rating model 120 to generate a function (expressed as F) according to the plurality of rates P and the estimated sales S;
Step S418: use the rating model 120 to generate a predetermined rate Pe according to the function F;
Step S420: determine if a current rate Pc in a plurality of channels is lower than the predetermined rate Pe; if so, enter Step S425; else, enter Step S435;
Step S425: use the allocation model 130 to adjust an allocation ratio Rt according to the estimated sales S and the predetermined rate Pe;
Step S430: determine a plurality of numbers corresponding to the plurality of channels according to the allocation ratio Rt; enter Step 480;
Step S435: close a sales operation of a channel corresponding to the current rate Pc, where the channel is one of the plurality of channels; and
Step S480: update the numbers of products allocated to the plurality of channels.

Below, an example is provided to explain the steps in the method 400. In the example, the products can be a plurality of hotel room nights. In Step S410, a plurality of room rates P can be inputted into the sales estimation model 110 to generate the estimated sales S, and the unit of the estimated sales S can be room night.

When the rates are higher, the profit per sale can be higher. However, if the rates are too high, it would lead to a decrease in sales. The estimated revenue can be positively related to the rates and the estimated sale S. In Step S415, the generated function F can be corresponding to an elastic curve. The upper bound of the rates (i.e. the predetermined rate Pe) can be estimated according to the slope of each point of the elastic curve. For example, the smallest slope on the elastic curve may correspond to the local maximal revenue, and may correspond to the predetermined rate Pe described in Step S418.

In Step S420, if the current rate Pc is lower than the predetermined rate Pe, the flow can enter Step S425 to continue to market the products through the channels. If the current rate Pc is higher than the predetermined rate Pe, and the product is no longer marketed by the channel corresponding to the current rate Pc. Steps S420 to S480 can be similar to Steps S220 to S280 in FIG. 2, and it is not repeated.

The system and flows in FIG. 1 to FIG. 4 can allocate a plurality of products to a plurality of marketing channels. The products can be hotel room nights, and the channels can include online travel agency channel(s), physical travel agency channel(s) and/or hotel self-operated channel(s). The products can be time-sensitive and perishable products such as air tickets, show tickets, sports tickets, etc.

The system and flows in FIG. 1 to FIG. 4 can use reinforcement learning to simulate the market environment and use neural networks (e.g. the rating model 120 and the allocation model 130) to estimate rates and allocate the products to the channels. The purpose of the system and flows is to effectively optimize the allocation ratio Rt and the rates in the marketing channels for maximizing the revenue. The data inputted to the rating model 120 and the allocation model 130 can be the estimated data generated by another machine learning model (e.g. the sales estimation model 110) and be the training features used in a second layer of a two-layered reinforcement learning.

The allocation model 130 can consider the prediction from a supply-and-demand model (e.g. the sales estimation model 110) and consider data generated by itself, external market data and data of competitors, so that the allocation model 130 can be trained and allocate products to different channels with a ratio. The rates of the products can be generated by an automated rating model (e.g. the rating model 120) for optimizing the revenue. Hence, through considering the effects of the allocation ratio in different channels and the automatically generated rates on one another, an optimal allocation ratio can be generated for optimizing the revenue.

A market demand model can calculate the upper rate bound and lower rate bound of the room rates in each channel, and the upper rate bound can be a highest allowable rate of a date, such as the predetermined rate Pe mentioned above.

After generating the allocation ratios with the allocation agent (e.g. the allocation model 130), revenues can be calculated accordingly, where the revenues can be corresponding to the rates generated automatically according to the allocation ratios. An allocation ratio corresponding to a highest revenue can be optimal and used to allocate products to the channels.

Then, it can be checked if each of the automatically generated rates is higher or lower than the upper rate bound of each channel. If the price of a product is lower than the upper rate bound, the product is likely to be accepted by the market. If the price of a product is higher than the upper rate bound, the product would be more difficult to sale, decreasing the revenue. Hence, the products allocated to the channel will be reallocated to other channels with more reasonable rates.

Here, two-layered reinforcement learning can be performed. In the first layer, a time series analysis can be performed according to historical data. In the automatic rating operation of the first layer, external environment factors can be features used to correct weights of the predicted values. In the second layer, the estimated data generated in the first layer can be used in a simulated market environment, and an agent model can simulate transactions and try different allocation ratios in the channels to find an optimal revenue. In different marketing channels, the cost of marketing the products (e.g. hotel room nights) may be different, and the costs can be parameters considered by the agent model. In the text, an agent model can be implemented with hardware and software.

In summary, through the system 100 and the methods 200 and 400, machine learning and neural networks can be used to dynamically adjust rates and an allocation ratio of perishable products (e.g. hotel room nights, air tickets, sports tickets, etc.) in a plurality of marketing channels for optimizing the revenue. Hence, the difficulties of allocating products in a plurality of marketing channels can be reduced. As a result, a solution for optimizing resources and managing inventory is provided.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for allocating perishable products based on machine learning, comprising:
using a sales estimation model to evaluate estimated sales of a plurality of perishable products in a predetermined period;
using a rating model to calculate a predetermined rate of the plurality of perishable products in the predetermined period according to the estimated sales;
using an allocation model to adjust an allocation ratio of the plurality of perishable products in a plurality of marketing channels according to the estimated sales and the predetermined rate if a current rate is lower than the predetermined rate; and
determining numbers of perishable products allocated to the plurality of marketing channels according to the allocation ratio.

2. The method of claim 1, further comprising:
inputting the numbers of perishable products allocated to the plurality of marketing channels into the rating model;
using the rating model to generate a plurality of rates corresponding to the plurality of marketing channels;
generating an estimated revenue according to the plurality of rates corresponding to the plurality of marketing channels;
updating the rating model and the allocation model to adjust the estimated revenue; and
generating an optimal rating model and an optimal allocation model according to a result of adjusting the estimated revenue.

3. The method of claim 1, further comprising:
generating an estimated revenue according to the estimated sales;
wherein using the rating model to calculate the predetermined rate of the plurality of perishable products in the predetermined period according to the estimated sales, comprises:
using the rating model to calculate the predetermined rate according to the estimated revenue and number of the plurality of perishable products.

4. The method of claim 1, wherein the plurality of perishable products comprise a plurality of hotel room nights, and the plurality of market channels comprise an online travel agency channel, a physical travel agency channel and/or a hotel self-operated channel.

5. The method of claim 1, wherein the sales estimation model, the rating model and/or the allocation model are updated to optimize an estimated revenue of the plurality of perishable products.

6. A method for arranging perishable products based on machine learning, comprising:
using a sales estimation model to evaluate estimated sales of a plurality of perishable products in a predetermined period;
using a rating model to calculate a predetermined rate of the plurality of perishable products in the predetermined period according to the estimated sales; and
closing a sales operation of a marketing channel corresponding to a current rate if the current rate is higher than the predetermined rate, wherein the marketing channel is one of a plurality of marketing channels.

7. The method of claim 6, further comprising:
allocating at least one perishable product in the marketing channel corresponding to the current rate to other marketing channels of the plurality of marketing channels.

8. The method of claim 6, further comprising:
generating an estimated revenue according to the estimated sales;
wherein using the rating model to calculate the predetermined rate of the plurality of perishable products in the predetermined period according to the estimated sales, comprises:
using the rating model to calculate the predetermined rate according to the estimated revenue and number of the plurality of perishable products.

9. The method of claim 6, wherein the plurality of perishable products comprise a plurality of hotel room nights, and the plurality of market channels comprise an online travel agency channel, a physical travel agency channel and/or a hotel self-operated channel.

10. The method of claim 6, wherein the sales estimation model and/or the rating model are updated to optimize an estimated revenue of the plurality of perishable products.

11. A method for arranging perishable products based on machine learning, comprising:
inputting a plurality of rates into a sales estimation model to evaluate estimated sales of a plurality of perishable products in a predetermined period;
using a rating model to generate a function according to the plurality of rates and the estimated sales;
using the rating model to generate a predetermined rate according to the function;
using an allocation model to adjust an allocation ratio according to the estimated sales and the predetermined rate if a current rate is lower than the predetermined rate; and
determining numbers of perishable products allocated to a plurality of marketing channels according to the allocation ratio.

12. The method of claim 11, wherein the plurality of perishable products comprise a plurality of hotel room nights, and the plurality of market channels comprise an online travel agency channel, a physical travel agency channel and/or a hotel self-operated channel.

13. The method of claim 11, wherein the sales estimation model, the rating model and/or the allocation model are updated to optimize an estimated revenue of the plurality of perishable products.
